(19) United States
(12) Patent Application Publication
(10) Pub. No.: US 2007/0001942 A1
(43) Pub. Date: Jan. 4, 2007

(54) Display screen comprising a plurality of cells

(75) Inventors: Mark Thomas Johnson, Eindhoven (NL); Arnoldus Theodorus Martinus Hendricus Van Keersop, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/556,451

(22) PCT Filed: May 11, 2004
(86) PCT No.: PCT/IB04/50632

§ 371 Date: Nov. 10, 2005

(30) Foreign Application Priority Data
May 15, 2003 (EP) 03101366.7

(51) Int. Cl. G09G 3/30

(52) U.S. Cl. 345/81

(57) ABSTRACT

The display screen (5) comprises a plurality of cells (2). Each cell (2) comprises a pixel (P) able to generate light (Lo) when driven by an electrical signal (I), a driver circuit (A) for providing the electrical signal (I) and a photosensitive device (D) for receiving optical display signals (Li) to control the pixel (P) via the driver circuit (A). The display system (6) has the display screen (5) and an optical image source (3) for transmitting optical display signals (Li) to each photosensitive device (D) of the plurality of cells (2).

The invention relates to a display screen comprising a plurality of cells. The invention also relates to a display system having a display screen comprising a plurality of cells.

GB 2,118,803A discloses a display device comprising a light source for producing light in dependence on an input display signal and an image-intensifying screen. The screen comprises a plurality of cells, each cell having an electroluminescent emitter and a photosensitive device connected to the electroluminescent emitter. The emitter produces light output in response to light received by the photosensitive device and originating from the light source. The light output in response to the light received by the photosensitive device is restricted by the characteristics of the photosensitive device and the electroluminescent emitter. So, for example, the ratio of light output and light received by the photosensitive device is fixed by these characteristics. Due to this fixed ratio it may not be possible to obtain a desired relation between the light output and the light from the light source.

It is an object of the invention to provide a display screen of the kind described in the opening paragraph, which enables to select a wide range of relations between the light output and the light received by the photosensitive device from the light source.

The object is achieved in that the display screen comprises a plurality of cells, each cell comprising a pixel for generating light when driven by an electrical signal, a driver circuit for providing the electrical signal, and a photosensitive device for receiving optical display signals to control the pixel via the driver circuit. The driver circuit may be adapted to generate a desired level of the electrical signal provided to the pixel, so the amount of light emitted by the pixel in response to optical display signals received by the photosensitive device is less restricted by the characteristics of the pixel and the photosensitive device. A cell may comprise more than one pixel, while each pixel in this cell may be coupled to one or more photosensitive devices. Alternatively, a cell may also comprise more than one photosensitive device, while each photosensitive device in this cell may be coupled to one or more pixels. The pixel may be of any type of light emitting element such as a Light Emitting Diode (LED), an element of a Field Emission Display (FED), an element of an Electroluminescent display, an organic LED or a Polymer LED. The term OLED may be used hereinafter when referring to an organic LED and/or a Polymer LED. The driver circuit may be any circuit comprising one or more active components for adapting the level, polarity or another parameter of the electrical signal.

The driver circuit may comprise a drive transistor. Such a transistor can, for example, be integrated in a relatively simple way in a cell of a display screen having an OLED as pixel.

It is advantageous if each cell further comprises a storage capacitor having a first and a second terminal, the drive transistor having a control terminal and a first and a second main terminal, the storage capacitor being coupled in parallel to the photosensitive device, the first terminal of the storage capacitor being coupled to the control terminal of the drive transistor, and the first main terminal of the drive transistor being coupled to the pixel. The storage capacitor acts as an integrating device by providing a voltage difference across the capacitor, which is proportional to an average value of the optical display signals received by the photosensitive device of the cell. If a relatively small storage capacitor is present, the capacitor is charged or discharged more rapidly as a result of the photocurrent induced in the photosensitive device by the optical display signals. This means that the voltage across the capacitor has relatively large fluctuations as a result of the photocurrent, which enables the use of a relatively simple driver circuit such as a drive transistor.

Each cell may further comprise a storage reset switch coupled to the first terminal of the respective storage capacitor to provide a storage reset voltage at the first terminal of the respective storage capacitor. By providing a storage reset voltage at the first terminal of the storage capacitor, the voltage across the storage capacitor may be set at a predefined level. This may be done repeatedly, for example, at the start of a frame period. As a result, the storage capacitor is discharged during the frame period depending on the optical display signals received by the photosensitive device during that frame period. So, in this way moving images, formed by a sequence of images at a rate equal to the frame rate, may be displayed on the display screen.

The second main terminal of the drive transistor of each cell may be coupled to a first supply voltage, and the second terminal of the storage capacitor to a reference voltage different from the first supply voltage. When the photosensitive device is discharging the storage capacitor, the voltage at the control terminal of the drive transistor changes towards the reference voltage. So, when, for example, the reference voltage is lower than the first supply voltage, the voltage at the control terminal may gradually diminish from, for example, the first supply voltage to the lower reference voltage. As a result, the current through the drive transistor coupled to the pixel gradually increases, resulting in an increase of the light output of the pixel. This means, an increase of the optical display signals results in an increase of the light output.

Each storage switch of the plurality of cells may be arranged to be operated according to a sequence of:

activating the storage reset switch for providing the storage reset voltage at the first terminal of the respective storage capacitor; and

deactivating the storage reset switch for enabling the respective photosensitive device to discharge the respective storage capacitor in dependence on the optical display signals.

Such a sequence requires relatively simple timing signals and is therefore easy to implement. If the reference voltage is lower than the first supply voltage, an increase of the optical display signals results in an increase of the light output. Moreover, the level of motion blur is relatively low, because, while the storage reset switch is deactivated, the light generated by a pixel gradually increases to a peak value.

The second main terminal of the drive transistor of each cell and the second terminal of the storage capacitor may be coupled to a first supply voltage.

The display screen may have a pixel switch coupled to each pixel of a number of the plurality of cells to constitute a group of cells and to alternately couple each pixel of the group of cells to a second supply voltage for turning off the pixel and to a third supply voltage for enabling the pixel to generate light. By means of the pixel switch the pixels may be turned off while, for example, the drive transistor is supplying current to the pixel. This allows, for example, to introduce a time interval within the frame period, wherein the storage capacitor is being charged or discharged in dependence on the optical display signals while any resulting current through the drive transistor does not generate any undesired light output. A group may be located in any way, for example a group may comprise the cells in an upper part or a lower part of the screen, the cells of one or more rows, the cells of one or more columns or cells of a particular type.

Alternatively, instead of applying a pixel switch, a signal source may be applied for providing the second and the third supply voltage.

Each storage switch of the group of cells and the pixel switch may be arranged to be operated according to a sequence of:

coupling each pixel of the group of cells via the pixel switch to the second supply voltage and activating each storage reset switch of the group of cells for providing the storage reset voltage at the first terminal of the respective storage capacitor;

deactivating each storage reset switch of the group of cells for enabling the respective photosensitive device coupled to the respective storage capacitor to discharge the respective storage capacitor in dependence on the optical display signals; and

coupling each pixel of the group of cells via the pixel switch to the third supply voltage.

If the reference voltage is equal to or larger than the first supply voltage, the voltage at the control terminal of the drive transistor may gradually increase from a starting value to the first supply voltage. As a result, the current through the drive transistor coupled to the pixel gradually decreases, resulting in a reduction of the light output of the pixel. This means that an increase of the optical display signals results in a decrease of the light output.

The photosensitive device may be selected from a poly-Silicon phototransistor, an amorphous-Silicon phototransistor and a PIN diode. The photosensitive device may also be a poly-Silicon phototransistor or an amorphous-Silicon phototransistor coupled as a diode by means of a connection between the control electrode and a main electrode.

The pixel and the photosensitive device may be selected from an Organic LED and a Polymer LED. In this case the screen is relatively simple to manufacture resulting in relatively low processing costs. Moreover, such a photosensitive device may be designed to be sensitive to a predefined range of wavelengths.

The display screen may have a front side for delivering light generated by each pixel of the plurality of cells, each photosensitive device of the plurality of cells being adapted to receive the optical display signals from a source positioned at a side of the screen facing away from the front side. Applying rear projection has the advantage that the photosensitive devices can relatively easily be positioned in such a way that they receive almost no light from the pixels. So, even if the optical display signals have the same spectrum as the spectrum of the light generated by the pixels, there will be little or no interference. Alternatively, front projection may be applied.

It is advantageous if each photosensitive device of the plurality of cells is adapted to receive optical display signals of non-visible light. By applying a source that generates optical display signals outside the visible light spectrum, interference between the optical display signals and visible light generated by the screen is avoided. Moreover, such a screen is not sensitive to ambient lighting conditions.

The invention further provides a display system that comprises a display screen as described before and an optical image source for transmitting optical display signals to each photosensitive device of the plurality of cells.

The optical image source may be selected from a projection device and a laser scanner.

In an embodiment the pitch of the cells of the screen is smaller than the pitch of the picture elements of a highest resolution image projected by the optical image source on the screen. In this embodiment the optical image source may generate any format image from a low resolution up to the highest resolution. The display screen is capable of reproducing each of the picture elements of the highest resolution image projected on the screen. If an image with a resolution lower than the highest resolution is projected on the screen, then for each picture element several cells are available for generating the light corresponding to that picture element. In this case, if one of the several cells would fail, then only the brightness contribution of the cell that failed will be lost in the light for reproducing that pixel element.

These and other aspects of the screen and system of the invention will be further elucidated and described with reference to the drawings, in which:

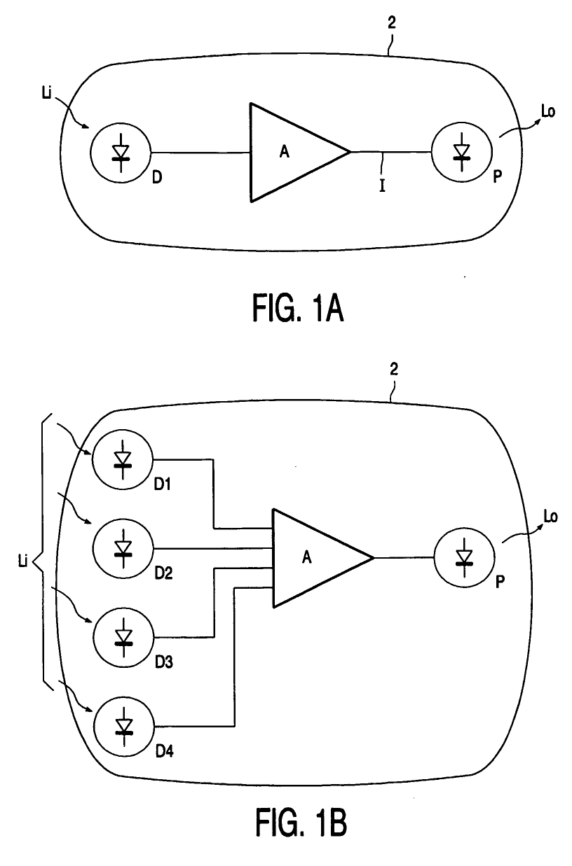

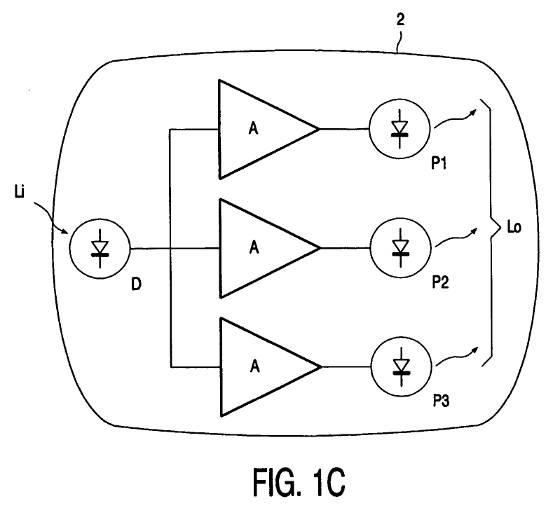

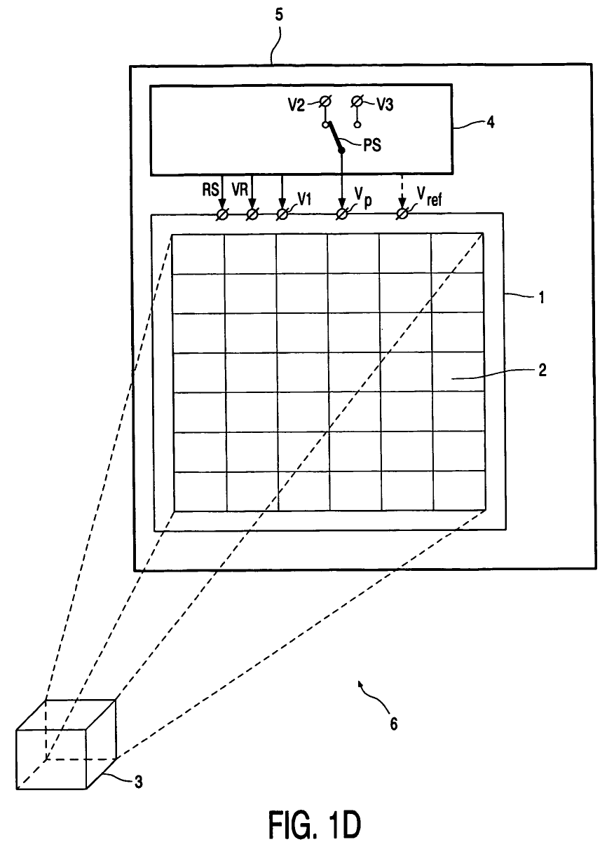

FIGS. 1A to 1C show block diagrams of embodiments of a cell applied in the display screen according to the invention;

FIG. 1D shows a block diagram of an embodiment of the display system according to the invention;

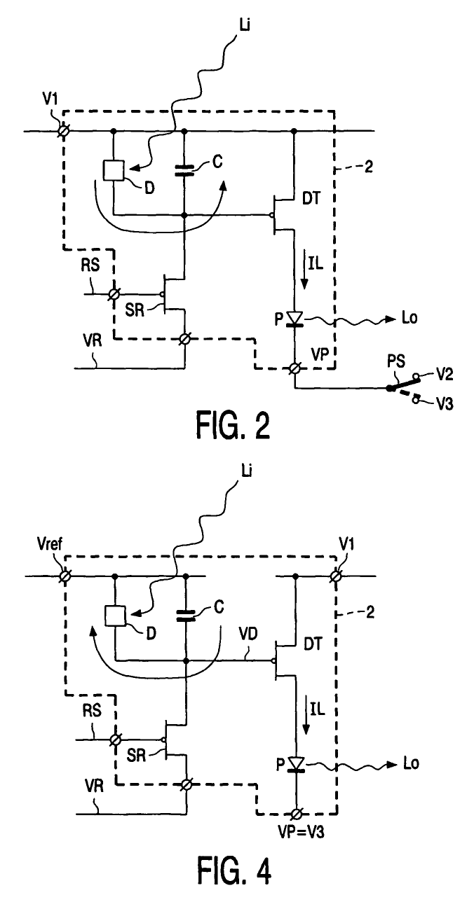

FIG. 2 shows a more detailed schematic diagram of an embodiment comprising a cell 2 as shown in FIG. 1A;

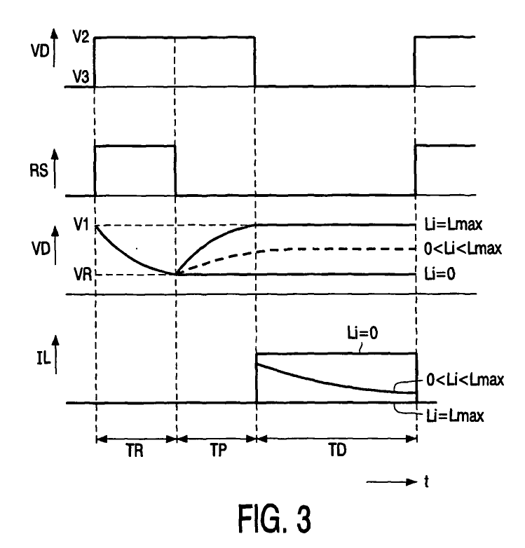

FIG. 3 shows waveforms of the diagram of FIG. 2;

FIG. 4 shows a more detailed schematic diagram of another embodiment comprising a cell 2 as shown in FIG. 1A; and

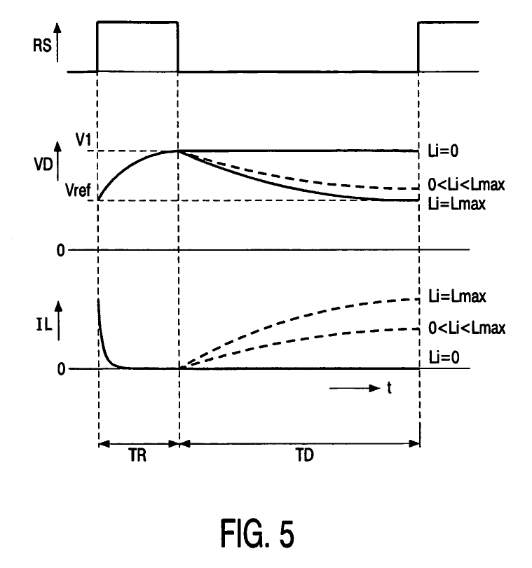

FIG. 5 shows waveforms of the diagram of FIG. 4.

The same references in different Figs. refer to the same signals or to elements performing the same function. The embodiment of a cell 2 applied in the display screen according to the invention as shown in FIG. 1A comprises a photosensitive device D, a driver circuit A and a pixel P. The photosensitive device D receives optical display signals Li, for example from an optical image source. The optical display signals Li, which may be formed by light within or outside the visible spectrum induces a photocurrent in the photosensitive device D. The photocurrent is converted by the driver circuit A into an electrical signal I which drives the pixel P. As a result, the pixel P generates light Lo in dependence on the electrical signal I, which in turn depends on the external control signal Li.

In FIG. 1B is shown an embodiment of a cell 2 comprising several photosensitive elements D1, D2, D3, D4. These photosensitive elements D1, D2, D3, D4 are connected to one driver circuit A, which drives the pixel P. Alternatively (not shown), one or more of the photosensitive elements D1, D2, D3, D4 may be connected to one or more other driver circuits A, while each driver circuit A is coupled to the pixel P.

In FIG. 1C is shown an embodiment of a cell 2 comprising a photosensitive device D and several pixels P1, P2, P3. Each of these pixels is driven by a driver circuit A, which provides an electrical signal based on the photocurrent of the photosensitive device D. Alternatively (not shown), one or more of the pixels P1, P2, P3 may be driven by the same photosensitive device D.

The display system 6 shown in FIG. 1D comprises a display screen 5 and an optical image source 3. The display screen comprises a display panel 1 and control circuitry 4. The display panel 1 comprises a plurality of cells 2 arranged in a matrix of rows and columns. The panel 1 does not require any row or column electrodes as each cell 2 is addressed via an external optical image source 3. For this reason the cells 2 may be arranged in any arbitrary configuration, so apart from a configuration in rows and columns, also other configurations like, for example, radial, diagonal or circular configurations may be applied. The cells 2 may also have a large variety of shapes. The panel 1 has four connections for receiving four signals from a control circuit 4:

a reset voltage VR,

a reset signal RS,

a first supply voltage V1 and

a pixel voltage VP.

The panel 1 may also have an additional connection for receiving a reference voltage Vref.

The four signals, and the reference voltage Vref if present, are coupled to each cell 2 of the panel 1.

Each cell 2 receives corresponding optical display signals Li from the source 3. The optical display signals Li are converted into light Lo generated by the pixel P in a cell 2 via the photosensitive device D and the driver circuit A. As a wide range of levels of the electrical signal I may be applied as a result of the gain of the driver circuit A, a low brightness image source 3 may be used to project the optical display signals Li on the panel 1 in order to generate an image with a high brightness.

The control circuit 4 comprises timing circuitry for generating the repetitive waveform of the reset signal RS. In a particular embodiment the control circuit 4 generates also a variable pixel voltage VP, which is varied between two levels in synchronism with the reset signal RS. The variable pixel voltage VP may be generated by a circuit providing such a waveform. Alternatively, a pixel switch PS may be used which has an output terminal, which is alternately coupled to a second supply voltage V2 and a third supply voltage V3.

FIG. 2 shows a more detailed schematic diagram of an embodiment comprising a cell 2 as shown in FIG. 1A. The cell 2 comprises the photosensitive device D coupled parallel to a storage capacitor C having a first terminal and a second terminal. The second terminal of the storage capacitor C is coupled to the first supply voltage V1. The first terminal is coupled via the main terminals of a storage reset switch SR to a reset voltage VR. A control terminal of the storage reset switch is coupled to receive the reset signal RS. In this embodiment the driver circuit A comprises a drive transistor DT. A first main terminal of the drive transistor DT is coupled to the first supply voltage V1, the control terminal of the drive transistor DT is coupled to the first terminal of the storage capacitor C and a second main terminal of the drive transistor DT is coupled to a first terminal of the pixel P, which in this embodiment is an OLED. A second terminal of the pixel P is coupled to the pixel voltage VP. The electrical signal I is a current IL flowing through the drive transistor DT and the pixel P in this embodiment.

The operation of the cell 2 will be explained below with reference to the waveforms as a function of time t as shown in FIG. 3.

During a reset time interval TR the reset switch SR is closed by the reset signal RS, as indicated by a high level of the reset signal RS. Via the reset switch SR the reset voltage VR, which may be a fixed voltage, is coupled to the first terminal of the storage capacitor C. As a result, the control voltage VD at the control terminal of the drive transistor DT will quickly reach the level of the reset voltage VR. During the reset time interval TR and a subsequent projection interval TP wherein the photosensitive device D is receiving optical display signals Li, the pixel P should not generate light Lo. This is achieved by setting the pixel voltage VP at a high value, being the second supply voltage V2. This second supply voltage V2 may be substantially equal to the first supply voltage V1 as shown in FIG. 3. The reset voltage VR is lower than the first supply voltage V1 in this embodiment. During the projection time interval TP the optical display signals Li received by the photosensitive device D result in a photocurrent indicated by an arrow in FIG. 2, which discharges the storage capacitor C. When no optical display signals Li are received, the storage capacitor C is not discharged, so the control voltage VD remains constant, indicated by the curve “Li=0”. When the optical display signals Li correspond to a maximum level Lmax, the storage capacitor C is substantially completely discharged during the projection time interval TP, resulting in the curve indicated by “Li=Lmax”. When the optical display signals Li correspond to a level between zero and the maximum level Lmax, the storage capacitor C is partially discharged during the projection time interval TP, resulting in the curve indicated by “0<Li<Lmax”.

During a drive time interval TD the pixel voltage VP is set at a low value, being the third voltage V3, which may be ground level. This enables the flow of the current IL through the drive transistor DT and the pixel P. This current IL depends on the control voltage VD. In case Li=Lmax, the control voltage VD is at its maximum value and remains at that value during the remainder of the drive time interval TD. As a result, the current IL remains zero and the pixel P does not generate light Lo. In case Li=0, the control voltage VD is at its minimum value, being the reset voltage VR and remains at that value during the remainder of the drive time interval TD. As a result, the current IL remains at its maximum value and the pixel P generates a maximum level of light Lo.

In case 0<Li<Lmax, the control voltage VD is at an intermediate value between the reset voltage VR and the first supply voltage V1 and continues to increase during the remainder of the drive time interval TD in dependence on the optical display signals Li. As a result the current IL starts at an intermediate value and drops gradually during the drive time interval TD as long as the control voltage VD continues to increase, so the pixel P generates an intermediate level of light Lo. Alternatively, the optical signals Li may be turned off during the drive time interval TD. In this case the control voltage VD and the current IL remain substantially constant during the drive time interval TD.

So, the level of light Lo emitted by the pixel P is inversely proportional to the optical display signals Li. A display screen 5 equipped with such cells 2 displays an inverse image of an image projected on the screen by the source 3.

FIG. 4 shows a more detailed schematic diagram of another embodiment comprising a cell 2 as shown in FIG. 1A. The differences with respect to the diagram shown in FIG. 2 are:

The second terminal of the storage capacitor C is coupled to a reference voltage Vref different from the first supply voltage V1, while the photosensitive device D is still coupled in parallel to the storage capacitor C and

The variable pixel voltage VP is replaced by a fixed third supply voltage V3.

The operation of the embodiment of the cell 2 shown in FIG. 4 will be explained below with reference to the waveforms as a function of time t as shown in FIG. 5.

During a reset time interval TR the reset switch SR is closed by the reset signal RS, as indicated by a high level of the reset signal RS. Via the reset switch SR the reset voltage VR, which may be a fixed voltage, is coupled to the first terminal of the storage capacitor C. As a result, the control voltage VD at the control terminal of the drive transistor DT will quickly reach the level of the reset voltage VR. The reset voltage VR is preferably substantially equal to the first supply voltage V1, while the reference voltage Vref is preferably lower than the first supply voltage V1. During the drive time interval TD the optical display signals Li received by the photosensitive device D result in a photocurrent, indicated by an arrow in FIG. 4, which discharges the storage capacitor C. When no optical display signals Li are received the storage capacitor C is not discharged, so the control voltage VD remains constant, indicated by the curve “Li=0”. When the optical display signals Li correspond to a maximum level Lmax, the storage capacitor C is substantially completely discharged during the drive time interval TD, resulting in the curve indicated by “Li=Lmax”. When the optical display signals Li correspond to a level between zero and the maximum level Lmax, the storage capacitor C is partially discharged during the drive time interval TD, resulting in the curve indicated by “0<Li<Lmax”.

During the drive time interval TD the current IL flows through the drive transistor DT and the pixel P. This current IL depends on the control voltage VD. In case Li=Lmax, the control voltage VD gradually decreases to a minimum value, which may be the reference voltage Vref, during the drive time interval TD. As a result, the current IL gradually increases to a maximum value and the pixel P generates a maximum level of light Lo. In case Li=0, the control voltage VD is at its maximum value, being in this example the first supply voltage V1 and remains at that value during the remainder of the drive time interval TD. As a result, the current IL remains zero and the pixel P does not generate light Lo.

In case 0<Li<Lmax, the control voltage VD gradually decreases to an intermediate value between the reset voltage VR and the first supply voltage V1 during the drive time interval TD in dependence on the control signal Li. As a result, the current IL gradually increases to an intermediate value during the drive time interval TD, so the pixel P generates an intermediate level of light Lo.

So the level of light Lo emitted by the pixel P is proportional to the optical display signals Li. A display screen 5 equipped with such cells 2 displays a positive image of an image projected on the screen by the source 3.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display screen (5) comprising a plurality of cells (2), each cell (2) comprising:
a pixel (P) for generating light (Lo) when driven by an electrical signal (I);
a driver circuit (A) for providing the electrical signal (I); and
a photosensitive device (D) for receiving optical display signals (Li) to control the pixel (P) via the driver circuit (A).

2. A display screen (5) as claimed in claim 1, the driver circuit (A) comprising a drive transistor (DT) having a control terminal and a first and a second main terminal, each cell (2) further comprising a storage capacitor (C) having a first and a second terminal and being coupled in parallel to the photosensitive device (D), the first terminal of the storage capacitor (C) being coupled to the control terminal of the drive transistor (DT), and the first main terminal of the drive transistor (DT) being coupled to the pixel (P).

3. A display screen (5) as claimed in claim 2, each cell (2) further comprising a storage reset switch (SR) coupled to the first terminal of the respective storage capacitor (C) to provide a storage reset voltage (VR) at the first terminal of the respective storage capacitor (C).

4. A display screen (5) as claimed in claim 3, the second main terminal of the drive transistor (DT) of each cell (2) being coupled to a first supply voltage (V1), and the second terminal of the storage capacitor (C) being coupled to a reference voltage (Vref) different from the first supply voltage (V1).

5. A display screen (5) as claimed in claim 4, each storage reset switch (SR) of the plurality of cells (2) being arranged to be operated according to a sequence of:
activating the storage reset switch (SR) for providing the storage reset voltage (VR) at the first terminal of the respective storage capacitor (C); and
deactivating the storage reset switch (SR) for enabling the respective photosensitive device (D) to discharge the respective storage capacitor (C) in dependence on the optical display signals (Li).

6. A display screen (5) as claimed in claim 3, the second main terminal of the drive transistor (DT) and the second terminal of the storage capacitor (C) of each cell (2) being coupled to a first supply voltage (V1).

7. A display screen (5) as claimed in claim 6, having a pixel switch (PS) coupled to each pixel (P) of a number of the plurality of cells (2) to constitute a group of cells (2) and to alternately couple each pixel (P) of the group of cells (2) to a second supply voltage (V2) for turning off the pixel (P) and to a third supply voltage (V3) for enabling the pixel (P) to generate light.

8. A display screen (5) as claimed in claim 7, each storage reset switch (SR) of the group of cells (2) and the pixel switch (PS) being arranged to be operated according to a sequence of:
coupling each pixel (P) of the group of cells (2) via the pixel switch (PS) to the second supply voltage (V2) and activating each storage reset switch (SR) of the group of cells (2) for providing the storage reset voltage (VR) at the first terminal of the respective storage capacitor (C);
deactivating each storage reset switch (SR) of the group of cells (2) for enabling the respective photosensitive device (D) coupled to the respective storage capacitor (C) to discharge the respective storage capacitor (C) in dependence on the optical display signals (Li); and
coupling each pixel (P) of the group of cells (2) via the pixel switch (PS) to the third supply voltage (V3).

9. A display screen (5) as claimed in claim 1, having a front side for delivering light (Lo) generated by each pixel (P) of the plurality of cells (2), each photosensitive device (D) of the plurality of cells (2) being adapted to receive the optical display signals (Li) from a source positioned at a side of the screen (5) facing away from the front side.

10. A display screen (5) as claimed in claim 1, each photosensitive device (D) of the plurality of cells (2) being adapted to receive optical display signals (Li) of non-visible light.

11. A display system (6) comprising a display screen (5) as claimed in claim 1, and an optical image source (3) for transmitting optical display signals (Li) to each photosensitive device (D) of the plurality of cells (2).

12. A display system (6) as claimed in claim 11, the optical image source (3) being selected from a projection device and a laser scanner.
